(19) United States
(12) Patent Application Publication
(10) Pub. No.: US 2001/0051034 A1
(43) Pub. Date: Dec. 13, 2001

(54) Tape recorder

(75) Inventor: Shinichiro Okamura, Osaka (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Sanyo Electric Co., Ltd.,, Moriguchi-shi (JP)

(21) Appl. No.: 09/878,388

(22) Filed: Jun. 12, 2001

(30) Foreign Application Priority Data
Jun. 13, 2000 (JP) 2000-176993

(51) Int. Cl. H04N 5/76; G11B 5/09

(52) U.S. Cl. 386/46; 386/109

(57) ABSTRACT

A VCR embodying the invention comprises a memory 78 for storing video signals to be recorded on the tape 10, a control circuit 77 for controlling rotation of a capstan and two reel tables to set various operation modes and controlling write and read of the video signals to the memory 78. The control circuit 77 executes repeatedly a first control operation wherein the tape 10 is moved in a forward direction recording the time-compressed video signals to be read from the memory means on the tape 10, a second control operation wherein the tape 10 is rewound up to a position closer toward a tape head than a position wherein the recording operation has been terminated, and a third control operation wherein the tape 10 is moved to the position wherein the recording operation has been terminated, and thereafter, follows to the recording operation. With the VCR, a transition recording can be performed even in an intermittent recording operation, and recording operation is not interrupted with recording check. Further, high reliability is obtained in measuring and determining a reproducing head output.

### FIELD OF THE INVENTION

The present invention relates to tape recorders such as video cassette recorders (VCRs), and more particularly to a construction and control of a tape recorder which is connected to a monitoring video camera, etc. to record over a long period of time.

### BACKGROUND OF THE INVENTION

With reference to FIG. 5, VCRs generally comprise a supply reel table 3, a take-up reel table 31, a rotary head cylinder 2, a capstan 44, a plurality of guide pins 42 for providing a specified tape transport path mounted on a chassis 1. With a tape cassette (not shown) loaded on the supply reel table 3 and the take-up reel table 31, a pair of leading guide posts, 4, 41 advances along respective guide grooves 11, 12, and moving a tension pin 43 toward a tape pulling-out direction to have a magnetic tape 10 pulled out from the tape cassette causing the tape to be wound around the cylinder 2.

Further, the supply reel table 3, shown in FIG. 6, is coupled to a tape tension mechanism 60 for giving the magnetic tape 10 a determined tape tension. The tape tension mechanism 60 comprises a brake belt 6 wound around an outer periphery of the supply reel table 3, a tension lever 61 connected to one end of the belt 6 and having a tension pin 43 extended thereof, and a spring 62 which biases the lever 61 counterclockwise. When the magnetic tape 10 is pulled out by the tension pin 43 as illustrated, the tape 10 is given an appropriate tension by the tension pin 43.

The supply reel table 3 is integrally molded from resin having a shape in section shown in FIG. 3. The table 3 is provided with an outer periphery 3a around which the brake belt 6 constituting the tape tension mechanism 60 is wound, and a gear portion 3b for exerting rotating force of tape-winding direction.

With a video cassette recorder (VCR) which is connected to a monitoring video camera to record over a long period of time, a method of intermittent recording is used, that is the capstan 44 and the take-up reel table 31 are rotated intermittently causing the magnetic tape 10 to move and stop repeatedly to record video signals on the moving tape 10.

FIG. 9 shows a control procedure of the intermittent recording on the VCRs described. First, in step S21 intermittent recording is actuated, and an inquiry is made as to whether a magnetic tape is in a stop state in step S22. When the answer is affirmative, step S26 follows to process signal reproducing on a track for stopping position, that is a last track on which recording has been performed, to measure output (reproducing head output) reproduced from the track.

Subsequently, an inquiry is made as to whether the reproducing head output is equal to or greater than standard value in step S27. If the answer is affirmative, step S21 follows to repeat the intermittent reproducing operation. On the other hand, if the answer is negative in step S27, it is considered that a head clogging occurs to the magnetic head installed on the rotary head, and step S28 follows to output a head-clogging warning.

Thereafter, an inquiry is made as to whether recording operation is ordered to terminate. When the answer is negative, step S21 follows again to repeat the intermittent reproducing operation. When the answer is affirmative, the procedure is terminated.

On the other hand, if the answer is negative in step S22, step S23 follows to make an inquiry as to whether check recording is ordered by the user. If the answer is negative, step S21 follows again to repeat the intermittent recording operation. On the other hand, If the answer is affirmative in step S23, step S24 follows to terminate the recording operation. Subsequently, the tape is rewound in a specified amount to reproduce video signals from a track in the position in step S25, and then step S21 follows again to repeat the intermittent recording operation.

With the control procedure described, the intermittent recording is so operated that only one filed of video signals out of consecutive six fields of video signals are to be recorded on the magnetic tape 10, to achieve six times recording time as usual operation.

When the repetition of signal recording operation brings a magnetic head mounted on the rotary head cylinder into head clogging decreasing the reproducing head output equal to or less than the standard value, the warning sign is presented. This enables the user to stop the VCR when required and to clean the rotary head cylinder.

Furthermore, the user can confirm as to whether normal recording is performed according to a reproduced image (static image).

However, the conventional VCRs of intermittent recording have a problem of an image disturbance every time the magnetic tape is moved or stopped since it takes some ramp time until a tape speed reaches a specified speed when the magnetic tape in a stopped mode starts to move.

Further, there rises a problem of image loss during the period of tape rewinding and reproducing (shown in step S25 of FIG. 9) since the user manipulates to check recording to interrupt the recording operation (shown in step S24 of FIG. 9).

Furthermore, the reproducing head output is measured and determined (shown in steps S26, S27 of FIG. 9) while the intermittent recording operation is in tape stopping mode. Therefore, in the case where image for 960 hours is recorded on 120 minutes tape (T120), for instance, with the intermittent operation, the tape stopping period is so short as equal to or less than 8 seconds. Thus there is a problem that it is difficult to make reliable measurement and determination.

### SUMMARY OF THE INVENTION

An object of the present invention is to provide a tape recorder which is capable to perform transit recording without image disturbance with an intermittent recording operation, which does not interrupt the recording operation even in recording check, and which is capable to obtain high reliability in measuring and determining the reproducing head output.

The tape recorder embodying the invention comprises memory means for storing video signals to be recorded on a tape 10, control means for controlling the rotation of a capstan 44 and two reel tables 5, 31 to set various operation modes, and controlling write and read of the video signals to the memory means.

The control means executes repeatedly a first control operation for drivingly rotating a take-up reel table 31 in a tape winding direction to have the tape 10 moved in a forward direction, recording the time-compressed video signals to be read from the memory means on the tape 10, a second control operation for drivingly rotating a supply reel table 5 in a tape winding direction to rewind the tape 10 up to a position closer toward a tape head than a position wherein the recording operation has been terminated, and a third control operation for drivingly rotating a take-up reel 31 in a tape winding direction to have the tape 10 moved to the position wherein the recording operation has been terminated, and thereafter, follows to the recording operation.

With the tape recorder of the invention described, video signals are recorded on the tape 10 according to the first control operation, and then the tape 10 is rewound according to the second control operation, thereafter to enable the tape 10 to run up to a position wherein the recording operation has been terminated, that is to say a position wherein a next recording starts according to the third control operation, so that the recording operation can start from the start position with a specified speed. Consequently, the transition recording is performed without the disturbance of recorded video signals.

The video signals to be recorded on the tape is time-compressed with every specified amount (one block), so that time margin is generated corresponding to rate of time compression during the period from the termination of recording for one block of video signals to the start of recording for next one block of video signals. For example, in the case where the memory means having a capacity for 144 fields of video signals stores one field to be extracted from 240 fields of video signals, and 10 seconds are required in magnetic recording operation, time margin is deduced to be 144×240/60−10=566 seconds. Consequently, the tape may be rewound or run-up, and so on, within the time margin period.

Stated specifically, the control means comprises reproducing head output measuring/determining means for reproducing signals from the tape 10 to measure output of the reproduced signals (reproducing head output) inquiring as to whether the measured value is equal to or greater than a standard value during the transition period from the termination of the second control operation to the third control operation. For the measurement and the determination of the reproducing head output, sufficient long period of time can be taken within the time margin period described.

With a specific construction, the control means comprises recording check means for reproducing video signals from the tape 10 to output the reproduced video signals to an external monitor during the transition period from the termination of the second control operation to the third control operation when the user orders recording check. The processing for reproducing and displaying the video signals can be performed within the margin time. Consequently, image recording of the first control operation will not be interrupted even in recording check.

With the tape recorder of the invention described above, transition recording can be performed without disturbance of recorded image even in the intermittent recording operation, recording operation is not interrupted even in recording check, and high reliability is obtained in measuring and determining the reproducing head output.

### BRIEF DESCRIPTION OF THE DRAWINGS

FIG. 1 is a block diagram showing the construction of the VCR embodying the invention;

FIG. 2 is a view in section showing a supply reel table mounted on the VCR embodying the invention;

FIG. 3 is a view in section showing a supply reel table mounted on a conventional VCR;

FIG. 4 is an exploded perspective view showing the supply reel illustrated in FIG. 2;

FIG. 5 is a plan view showing a tape moving path of the VCR;

FIG. 6 is a plan view showing the construction of a tape tension mechanism;

FIG. 7 is a flow chart showing control operation of the VCR embodying the invention when recording over a long period of time;

FIG. 8 is a diagram for illustrating a trace position change for a magnetic head relative to a magnetic tape on the VCR embodying the invention;

FIG. 9 is a flow chart showing control operation of a conventional VCR when recording over a long period of time;

### DETAILED DESCRIPTION OF EMBODIMENTS

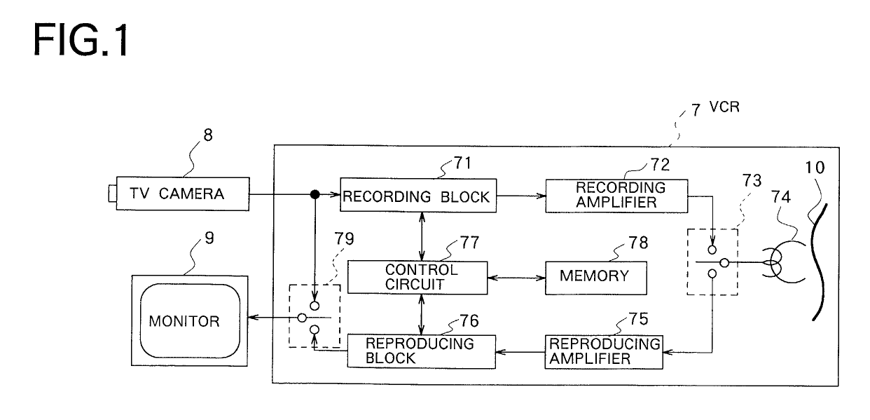

The present invention as embodied into a VCR will be described below in detail with reference to the drawings. With a VCR 7 shown in FIG. 1, video signals transmitted from a TV camera 8 can be recorded on a magnetic tape 10, and video signals reproduced from the magnetic tape 10 can be supplied to a monitor 9 or video signals transmitted from a TV camera 8 can be directly supplied to the monitor 9 to display an image shot by the TV camera 8.

In usual recording, video signals input from the TV camera 8 to the VCR 7 are supplied via a recording block 71, a recording amplifier 72, and a change-over switch 73 to a magnetic head 74 to be recorded on the magnetic tape 10. Further, video signals reproduced by the magnetic head 74 from the magnetic tape 10 are supplied via a change-over switch 73, a reproducing amplifier 75, a reproducing block 76, and a change-over switch 79 to the monitor 9 to have image displayed on a screen. Video signals transmitted from the TV camera 8 can be supplied via a change-over switch 79 directly to the monitor 9 to have image displayed on a screen. Operation of the recording block 71 and the reproducing block 76 is controlled by a control circuit 77.

On the other hand, in recording over a long period of time, while digital image data obtained from the recording block 71 is time-compressed to have the data stored in a memory 78, the image data read from the memory 78 is further converted to analogue video signal in the recording block 71, and thereafter to have the data supplied via the recording amplifier 72 and the change-over switch 73 to the magnetic head 74 and recorded on the magnetic tape 10. Image data can be so time-compressed that, for example, one field of image data is extracted from 240 fields of image data storing the data in the memory 78.

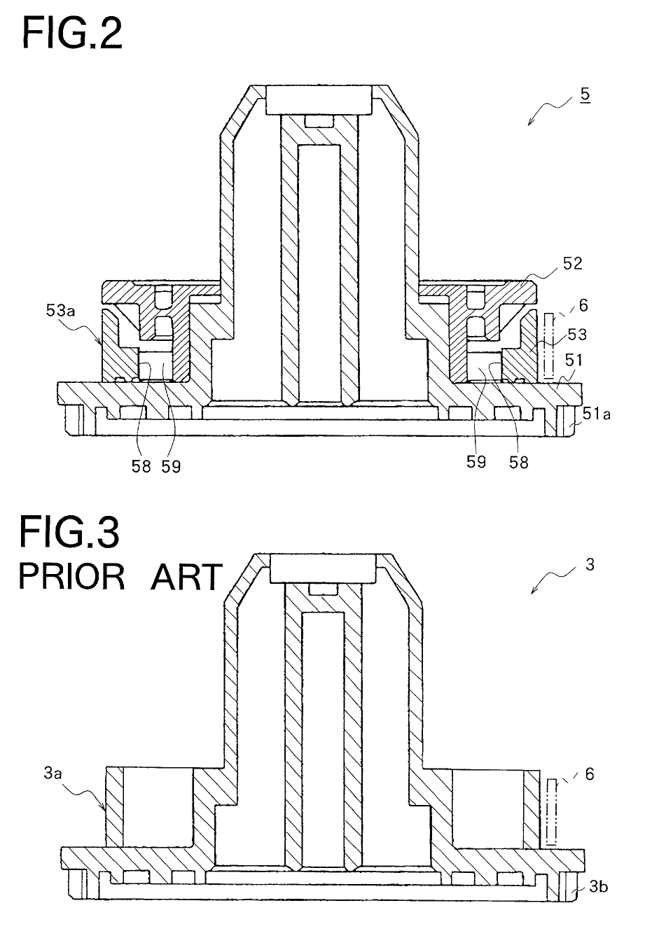

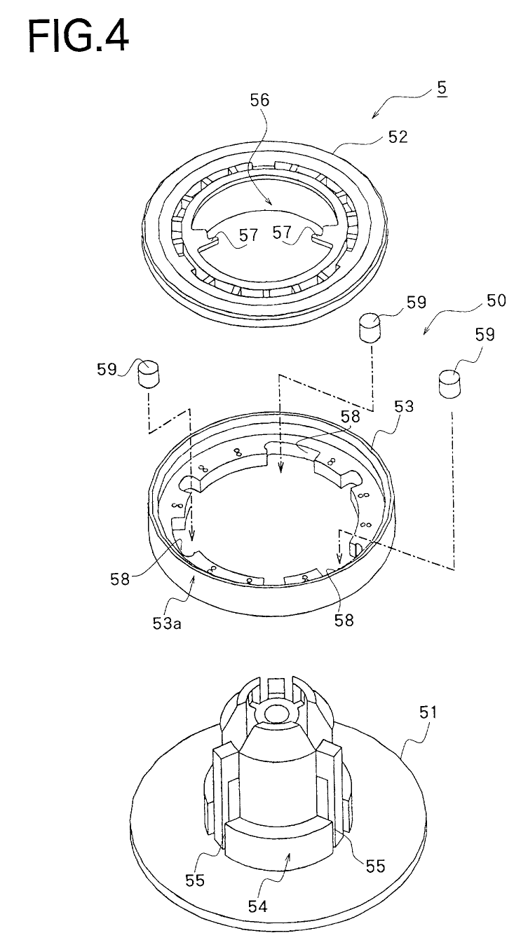

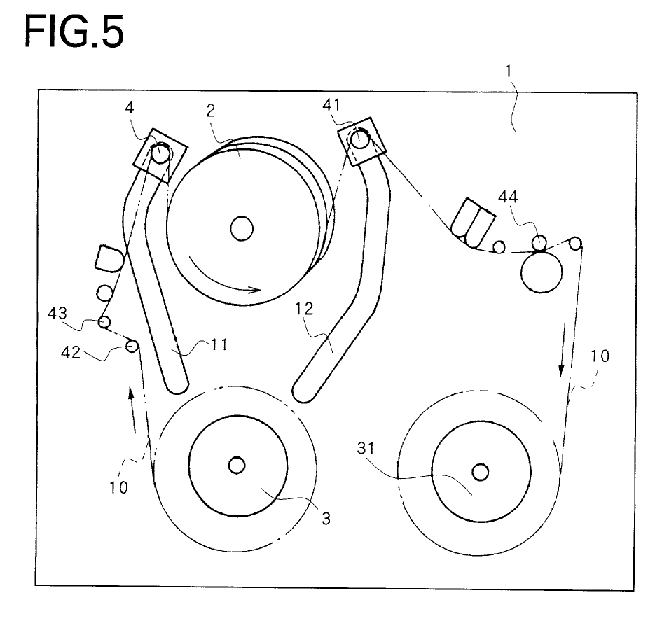

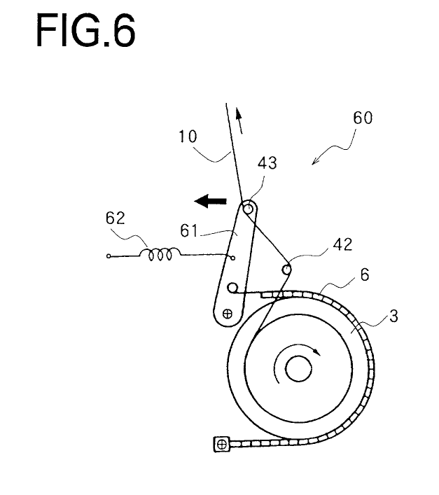

A supply reel table 5 shown in FIG. 2 and FIG. 4 is mounted on the VCR 7. The supply reel table 5 comprises a base member 51 having a gear portion 51a which exerts drivingly rotating force in a tape rewinding direction, a. cap member 52 fitted to the base member 51 and unable to rotate relative thereto, a drum member 53 engaged to the two members 51, 52 and free to rotate relative thereto.

An outer periphery 54 formed on the base member 51 is tightly fitted to an inner periphery 56 formed on the cap member 52, and a projection 57 formed on the cap member 52 is engaged with grooves 55, 55 formed on the base member 51 to have the base member 51 and the cap member 52 formed integrally. An outer periphery of the cap member 52 is opposed to an inner periphery of the drum member 53 each other. The inner periphery of the drum member 53 is formed with three engagement grooves 58 in the form of a planar wedge, and a roller 59 is so accommodated into each wedge-shaped engagement groove 58 as to be movable smoothly.

Accordingly, the plurality of wedge-shaped engagement grooves 58 and rollers 59 constitute a one-way clutch 50. When the drum portion 53 rotates counterclockwise relative to the base member 51 and the cap member 52, each roller 59 is in meshing engagement with a narrow portion of the wedge-shaped engagement grooves 58, bringing the one-way clutch 50 into a clutch engagement state wherein the base member 51 and the cap member 52 rotate integrally with the drum member 53. When the drum member 53 rotates clockwise relative to the base member 51 and the cap member 52, each roller 59 is so accommodated into a wide portion of the wedge-shaped engagement grooves 58 as to be movable smoothly bringing the one-way clutch 50 into a clutch release state wherein the drum member 53, the base member 51, and the cap member 52 are allowed to rotate relatively.

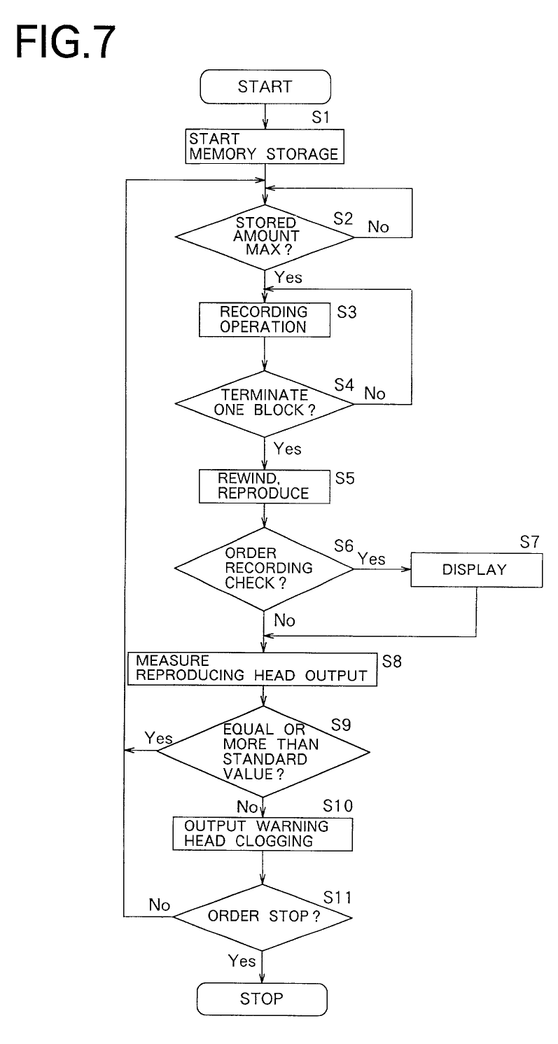

FIG. 7 shows control procedure wherein the VCR is in a long time recording mode. First in step S1 video signals obtained from a TV camera 8 are stored in a memory as digital data. In step S2, an inquiry is made as to whether stored amount of data to the memory reaches a maximum value (Max). The data continues to be stored until the answer is affirmative.

Thereafter, if the answer is affirmative in step S2, a recording mode in a forward direction is set to start recording video signals on the magnetic tape 10 in step S3. Then an inquiry is made as to whether an image recording is completed having one block data of a specified amount in step S4. If the answer is negative, step S3 follows again to continue recording.

Thereafter, if the answer is affirmative in step S4, step S5 follows to rewind the magnetic tape in a specified amount and then to reproduce one field of video signals from the track position. Subsequently, an inquiry is made as to whether recording check is ordered by a user in step S6. If the answer is affirmative, the reproduced video signals described are supplied to the monitor 9 to display image.

Thereafter, step S8 follows to measure output of video signals reproduced from the track (reproducing head output). In step S9 an inquiry is made as to whether the measured value is equal to or greater than the standard value. When the answer is affirmative, step S2 follows again to repeat the recording operation. After the second recording operation and later, the tape is moved up to a point of last recording termination without the signal recording, and subsequently the signal recording starts from the point of last recording termination. In contrast, when the answer is negative in step S9, step S10 follows to output a signal for warning a head clogging.

In step S11, an inquiry is made as to whether stop of the recording is ordered by the user. If the answer is negative, step S2 follows again to repeat the recording operation. If the answer is affirmative, terminate the procedure.

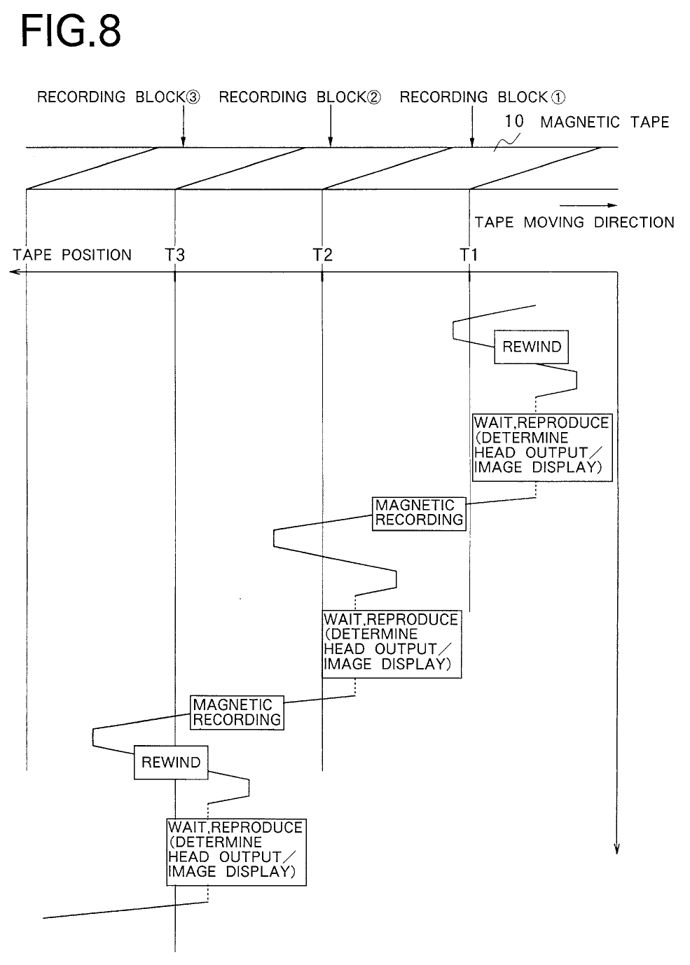

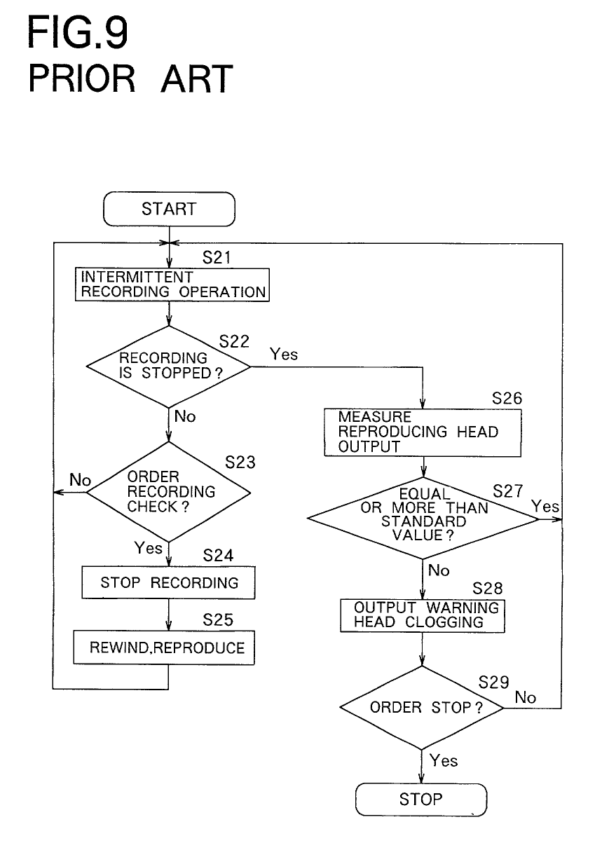

FIG. 8 shows change of a trace point of the magnetic head on the magnetic tape realized by the execution of the procedure described. In the case where the magnetic tape 10 moves to an arrow direction, the VCR is to be in a recording mode in a forward direction to magnetic-record one block of video signals read out from the memory on a tape section between a tape positions of T1 and T2 (first operation).

With a supply reel table 5 shown in FIG. 2, in this case, the one-way clutch 50 is in an engagement state to cause the drum member 53 to rotate integrally with the base member 51 and the cap member 52, so that a braking force of a brake belt 6 is applied to the outer periphery 53a of the drum member 53 giving an appropriate tension to the magnetic tape 10.

Subsequently, the magnetic tape 10, as shown in FIG. 8, is slightly moved from the tape position T2, and thereafter the tape 10 is rewound to stop the tape movement on a position closer to the tape position T1 than to the tape position T2 (second operation). In rewind of the tape 10, the VCR are not set in a reverse reproduction and a rewinding mode while set in a forward direction recording mode, the capstan 44 and the supply reel table 3 are rotated in the tape winding direction to move the tape 10 in the reverse direction.

With the supply reel table 5 shown in FIG. 2, in this case, the base member 51 and the cap member 52 drivingly rotate counterclockwise to release the engagement of the one-way direction clutch 50, whereby the drum member 53 is free to rotate relatively, with the result that a braking force of the brake belt 6 is applied to the drum member 53 bringing the drum member 53 into a stop state. Accordingly, the braking force of the brake belt 6 is not exerted on driving rotation of the supply reel table 5, so that the tape can be rewound with a minimum force required.

With respect to FIG. 8, the tape 10 is remained in a movement stop mode for a specified period of time. Within the period, a video signal is reproduced from a track of the stopped position to inquire whether a head output is equal to or greater than the standard value and to display an image (static image) corresponding to a user's order. Thereafter, the tape starts moving to run up, and a tape speed reaches a specified value, whereupon a magnetic recording starts for a next block \mathring{2} from the tape position T2 (third operation).

By the repetition of the first operation through the third operation described above, video signals time compressed every per unit block are consecutively recorded on the tape 10.

When the VCR described conducts the magnetic recording operation (transition recording) per block on the tape 10, a run-up segment is provided by rewinding the tape 10 to enable the VCR to start the recording operation in a state wherein the tape speed reaches the specified value, whereby there is no likelihood of disturbance of recorded image on a connecting portion of blocks.

Further, a head clogging can be checked and a processing for displaying a reproduced image (static image) can be conducted based on a reproducing head output during the period of stop of the magnetic tape due to an intermittent recording operation using a memory 78, so that the recording operation needs not to be interrupted. Moreover, since the reproducing head output can be checked over a sufficient long time, the check result obtains a high reliability.

Furthermore, with the supply reel table 5 shown in FIG. 2 and FIG. 4, an outer periphery 54 of the base member 51 and an inner periphery 56 of the cap member 52 fitted each other are in a same level position with an outer periphery of the cap member 52 and an inner periphery of the drum member 53, the one-way clutch 50 is provided on opposed portion of the two peripheries. Consequently, the supply reel table 5 has an almost same thickness as a conventional supply reel table 3 formed integrally.

The tape recorder of the present invention is not limited to the foregoing embodiment in construction but can be modified variously by one skilled in the art within the scope of the invention as set forth in the appended claims. For example, the one-way clutch 50 mounted on the supply reel table 5 needs not be limited to be constructed as shown FIG. 4, but can be given alternatively various one-way clutches already known. Further, the example described indicates that a static image generated from one field of video signals is to be displayed in confirmation of reproduced image during the intermittent recording operation, but a plurality of fields of video signals can be reproduced and to display an animation.

What is claimed is:

1. A tape recorder for positioning a tape (10) along a predetermined tape transport path from a supply reel table (5) through a rotary head cylinder (2) and a capstan (44) to a take-up reel table (31), drivingly rotating a capstan (44) and the reel table on a tape winding side, and recording signals on the tape (10) by the rotary head cylinder (2) while moving the tape (10), the tape recorder comprising:
memory means for storing video signals to be recorded on the tape (10) and control means for controlling the rotation of the capstan (44) and the two reel tables (5), (31) to set various operation modes and controlling write and read of the video signals to the memory means, and
the control means executing repeatedly a first control operation for drivingly rotating the take-up reel table (31) in a tape winding direction to have the tape (10) moved in a forward direction recording the compressed video signals to be read from the memory means on the tape (10), a second control operation for drivingly rotating the supply reel table (5) in a tape winding direction to rewind the tape (10) up to a position closer toward a tape head than a position wherein the recording operation has been terminated, and a third control operation for drivingly rotating the take-up reel (31) in a tape winding direction to have the tape 10 moved to the position wherein the recording operation has been terminated, and thereafter, following to the recording operation.

2. A tape recorder according to claim 1 wherein the control means comprises reproducing head output measuring/determining means for reproducing signals from the tape 10 to measure output of the reproduced signals determining as to whether the measured value is equal to or greater than a standard value during the transition period from the termination of the second control operation to the third control operation.

3. A tape recorder according to claim 1 wherein the control means comprises recording check means for reproducing video signals from the tape (10) to output the reproduced video signals to an external monitor during the transition period from the termination of the second control operation to the third control operation when the user orders recording check.
